(19) United States
(12) Patent Application Publication
(10) Pub. No.: US 2024/0142035 A1
(43) Pub. Date: May 2, 2024

(54) Conduit Bore Plugging Tool

(71) Applicants: David Sanjines, Houston, TX (US); Quanta Associates, L.P., Houston, TX (US)

(72) Inventors: David Sanjines, Stafford, VA (US); Nicholas Alexander Leas, Charlotte, NC (US); James Louis Kasprzak, Huntersville, NC (US)

(21) Appl. No.: 18/495,692

(22) Filed: Oct. 26, 2023

Related U.S. Application Data
(60) Provisional application No. 63/381,073, filed on Oct. 26, 2022.

(51) Int. Cl. F16L 55/128

(52) U.S. Cl. CPC F16L 55/128

(57) ABSTRACT

Conduit bore plugging for rapid selective plugging of a fluid path within a conduit has a driver handle having a motive chamber with a driving chamber, the motive chamber attached to the driver handle, wherein the motive chamber defines a passage. A shaft-like plugging device has a bar connected to a rod, wherein the bar is driven in a first direction by the driver handle via the driving chamber, and guided and supported by the motive via the passage. A fluid path in a conduit is selectively plugged with an expandable seal via expanding the expandable seal within the bore of the conduit by sliding a sleeve over a rod of the bar into a flange contiguous with an end of the expandable seal, and by engaging the sleeve at one end by interference with an abutment surface as the bar is driven via the driving chamber.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### BACKGROUND

Technical field: The subject matter generally relates to apparatus and techniques for selectively plugging the flow of fluid in or from a conduit, such as a pipe or pipeline.

In the performance of maintenance and repair activities for natural gas pipes or pipelines, situations may arise where gas can flow out to the environment. For example, when replacing older natural gas distribution pipes and/or tees, natural gas can leak or blow to the environment after cutting a pipe to remove and replace a tee.

In such a scenario according to the preceding paragraph, a traditional gas expansion plug or plug expander tool may be used. Traditional gas expansion plugs are known and are commercially available from INNER-TITE CORP under the brand name INNER-TITE. Using a traditional gas expansion plug tool is time consuming and may be unsafe because it is inefficiently required to be operated by turning a portion of the tool by using, for example, two hands and typically includes a wingnut (which may, by way of example only, take a minute or more to fully engage for plugging, which during that time natural gas may escape the pipe to be plugged and flow into the atmosphere).

### BRIEF SUMMARY

The present disclosure generally relates to embodiments of an apparatus for quickly and safely selectively plugging the flow of fluid from a conduit which may be a pipe or pipeline, and conversely for releasing same.

Additionally, the present disclosure relates to embodiments of methods of quickly and safely, selectively, plugging a bore of a conduit, and conversely for releasing same.

Accordingly, the apparatus and method for conduit bore plugging for rapid selective plugging of a fluid path within a conduit has a driver handle having a motive chamber with a driving chamber, the motive chamber attached to the driver handle, wherein the motive chamber defines a passage. A shaft-like plugging device has a bar connected to a rod, wherein the bar is driven in a first direction by the driver handle via the driving chamber, and guided and supported by the motive via the passage. A fluid path in a conduit is selectively plugged with an expandable seal via expanding the expandable seal within the bore of the conduit by sliding a sleeve over a rod of the bar into a flange contiguous with an end of the expandable seal, and by engaging the sleeve at one end by interference with an abutment surface as the bar is driven via the driving chamber.

### BRIEF DESCRIPTION OF THE DRAWINGS

The embodiments may be better understood, and numerous objects, features, and advantages made apparent to those skilled in the art by referencing the accompanying drawings. These drawings are used to illustrate only typical embodiments of this disclosure, and are not to be considered limiting of its scope, for the disclosure may admit to other equally effective embodiments. The figures are not necessarily to scale and certain features and certain views of the figures may be shown exaggerated in scale or in schematic in the interest of clarity and conciseness.

FIG. 1 depicts a side view of an exemplary embodiment of a conduit bore plugging apparatus.

FIG. 2 depicts a side view of an exemplary embodiment of a shaft-like plugging device.

FIG. 3A depicts a schematic sectional side view of an exemplary embodiment of a shaft-like plugging device.

FIG. 3B depicts a schematic sectional side view of an exemplary embodiment of a shaft-like plugging device as the bar is being driven and the plug is expanding.

FIG. 3C depicts a schematic sectional side view of an exemplary embodiment of a shaft-like plugging device where the plug is expanded.

FIG. 4 depicts a schematic view of an exemplary embodiment of the passage of the brace and rigid ring.

FIG. 5A depicts a perspective view of an exemplary embodiment of a conduit bore plugging apparatus plugging a fluid path of a conduit while grounded with a grounding line.

FIG. 5B depicts a perspective view of an exemplary embodiment of a grounding line that is grounded to the ground surface.

FIG. 6 depicts a side view of another exemplary embodiment of a conduit bore plugging apparatus.

FIG. 7 depicts a depicts a view of an exemplary embodiment of an adaptor.

FIG. 8 depicts a side view of another exemplary embodiment of a conduit bore plugging apparatus.

FIG. 9 depicts a schematic view of an exemplary embodiment of the passage of the motive chamber and a sleeve.

### DETAILED DESCRIPTION OF THE EMBODIMENT(S) SHOWN

The description that follows includes exemplary apparatus, methods, techniques, and instruction sequences that embody techniques of the inventive subject matter. However, it is understood that the described embodiments may be practiced without these specific details.

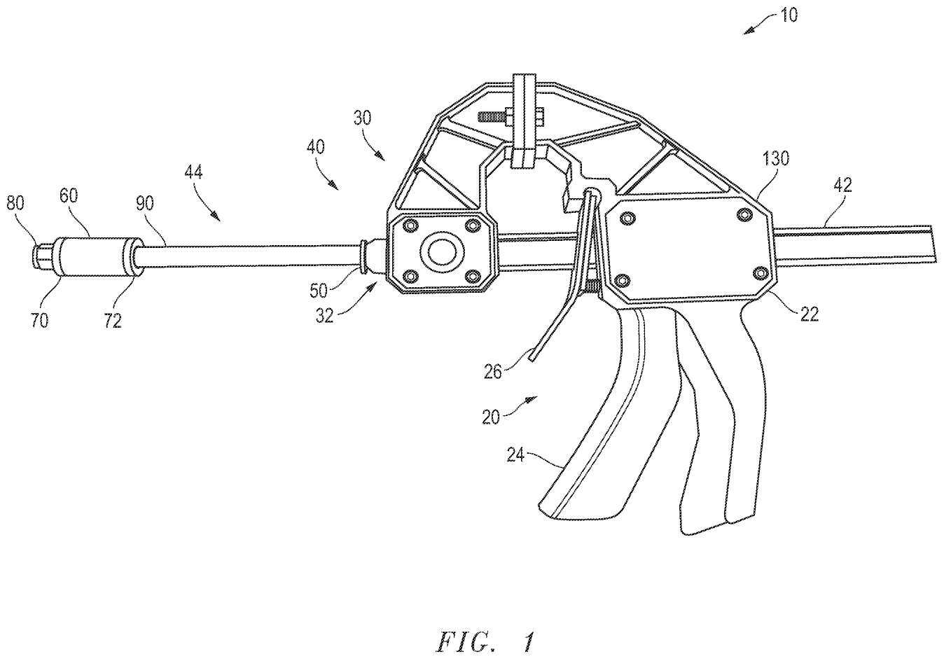

FIG. 1 depicts a side view of an exemplary embodiment of a conduit bore plugging apparatus 10 for rapid selective plugging of a fluid path within a conduit. The conduit bore plugging apparatus 10 may have a driver handle 20 having a motive chamber 130 with a driving chamber 22. The motive chamber 130 (shown with a connected, unitary, or integral guiding and supporting brace 30 in the exemplary embodiment of FIG. 1) may be attached (e.g., directly, indirectly, and/or unitary with, etc.) to the driver handle 20. The driver handle 20 may have a squeezable trigger 24 and a release trigger 26. The motive chamber 130 together with guiding and supporting brace 30 defines a passage 32. The conduit bore plugging apparatus 10 may further have a shaft-like plugging device 40 which comprises a bar 42 fixed to a rod 44. Rod 44 is an internal rod that is positioned inside of a rigid sleeve 90, which is hollow to permit passage of rod 44. Rod 44 may be threaded to accommodate cap nut 80 on one end, and at an opposite end of rod 44, be welded or otherwise fixed, attached, connected, or threaded to bar 42. The bar 42 may be driven in a first direction by the driver handle 20 via the driving chamber 22 of the motive chamber and guided and supported by the guiding and supporting brace 30 via passage 32, and bar 42 and driving chamber 22 may be released in a second direction via release trigger of the motive chamber 130. A rigid ring 50 is disposed around the rod 44 adjacent the bar. The rigid ring 50 may have a diameter that is greater than an opening dimension (e.g., the width) X of the passage 32 for creating interference between rigid ring 50 outer diameter/dimension Y and the opening dimension X of the passage 32 on abutment surface 132. An expandable seal 60 is disposed around the rod 44, such as at a distal end of rod 44 relative to a driven end of bar 42 that passes through driving chamber 22. A first flange 70 and second flange 72 are disposed around the rod 44. The first flange 70 may be attached to rod 44 near the distal end of the rod 44 and may be contiguous with one end of the expandable seal 60. The second flange 72 may be attached contiguous with another end of the expandable seal 60. A cap nut 80 may be fixed, such as with threads, to an end of the rod 44 abutting the first flange 70. Rigid sleeve 90 is disposed around the rod 44 adjoining and in-between the rigid ring 50 and the second flange 72. The rigid sleeve 90 is slidable over, and around, the rod 44. Stated slightly differently, rod 44 slides internally through rigid sleeve 90.

A guiding and supporting brace 30 may be made via modification of a trigger clamp or bar clamp used in workshop type clamping applications commercially available from THE BLACK & DECKER CORPORATION under the brand name IRWIN or IRWIN QUICK-GRIP, and another trigger clamp or bar clamp under the brand name DEWALT.

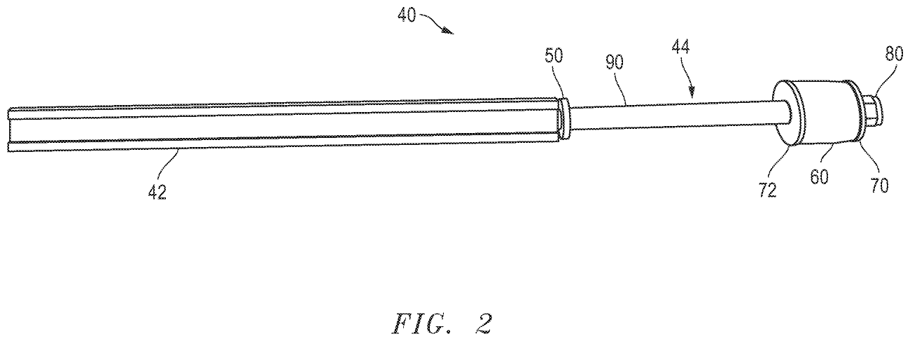

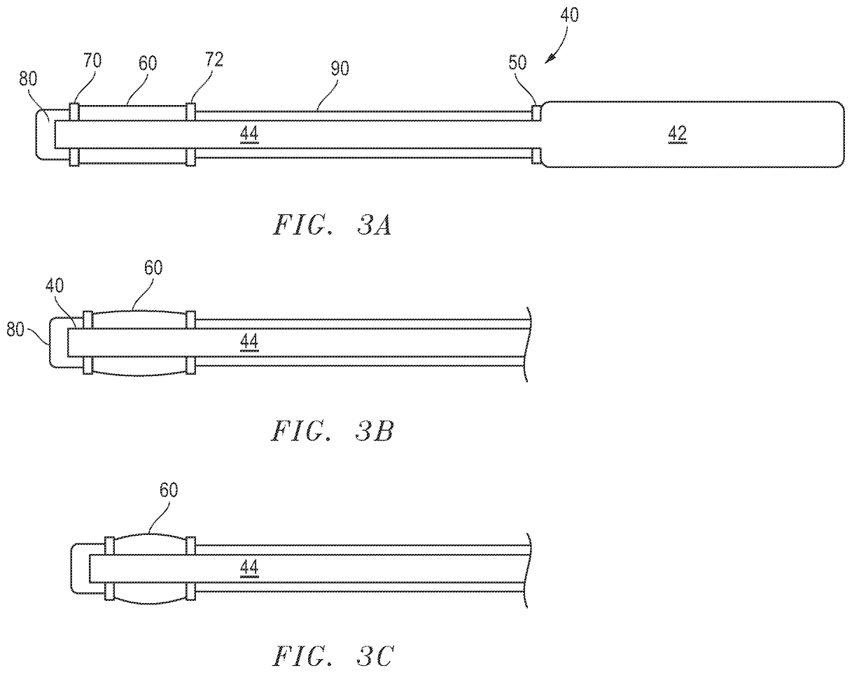

FIG. 2 depicts a side view of an exemplary embodiment of a shaft-like plugging device 40. The shaft-like plugging device 40 may comprise a bar 42 fixed to a rod 44 (hidden by sleeve 90 in FIG. 2 but viewable in FIGS. 3A, 3B, & 3C). By way of example only, the bar 42 may be welded to the rod 44. A rigid ring 50 is disposed around the rod 44 adjacent the bar 42. An expandable seal 60 is disposed around the rod 44. By way of example only, the expandable seal 60 may be a rubber plug, which may be hollow. A first flange 70 and second flange 72 are disposed around the rod 44. The first flange 70 may be attached near the distal end of the rod 44 and may be contiguous with one end of the expandable seal 60. The second flange 72 may be attached contiguous with another end of the expandable seal. A cap nut 80 may be fixed to an end of the rod 44 abutting the first flange 70. By way of example only, the cap nut 80 may be threaded onto the rod 44. A rigid sleeve 90 is disposed around the rod 44 adjoining and in-between the rigid ring 50 and the second flange 72. The rigid sleeve 90 is slidable over the rod 44.

FIG. 3A depicts a schematic sectional side view of an exemplary embodiment of a shaft-like plugging device 40 in a first position. FIG. 3B depicts a schematic sectional side view of an exemplary embodiment of a shaft-like plugging device 40 as the bar 42 is being driven and the plug 60 is expanding in a second position relative to FIG. 3A. FIG. 3C depicts a schematic sectional side view of an exemplary embodiment of a shaft-like plugging device 40 where the plug 60 is further expanded in a third position relative to FIG. 3B (and schematically potentially sealing the fluid path 14 of the conduit depending upon the outer diameter of the plug 60 and the inner diameter of the bore 14 of the fluid conduit 12). Referring to FIGS. 3A-3C, the shaft-like plugging device 40 may comprise a bar 42 fixed to a rod 44. An expandable seal 60 is disposed around the rod 44. A first flange 70 and second flange 72 are disposed around the rod 44. The first flange 70 may be attached near the distal end of the rod 44 and may be contiguous with one end of the expandable seal 60. The second flange 72 may be attached contiguous with another end of the expandable seal. A cap nut 80 may be fixed to an end of the rod 44 abutting the first flange 70. By way of example only, the cap nut 80 may be attached via threading at the distal end of the rod 46. A rigid sleeve 90 is disposed around the rod 44 adjoining and in-between the rigid ring 50 and the second flange 72. The rigid sleeve 90 is slidable over the rod 44.

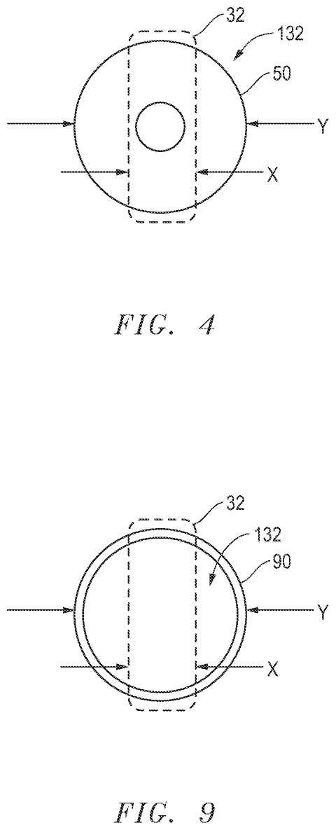

FIG. 4 depicts a schematic view of an exemplary embodiment of the passage 32 of the motive chamber 130 together with brace 30 (shown in FIGS. 1 & 5A) and rigid ring 50. By way of example only, the rigid ring 50 may have a diameter that is greater than an opening dimension (e.g., as shown in FIG. 4, the width) X of the passage 32 for creating interference between rigid ring 50 outer diameter/dimension Y and the opening dimension X of the passage 32 on abutment surface 132. The rigid ring 50 by interference with the abutment surface 132 of the brace 30 of motive chamber 130 may prevent the rigid sleeve 90 from passing into the passage 32 defined by the brace 30 (shown in FIGS. 1 & 5A) when the bar 42 is driven in the first direction by the driver handle 20 (shown in FIGS. 1 & 5A) via the driving chamber 22 (shown in FIGS. 1 & 5A).

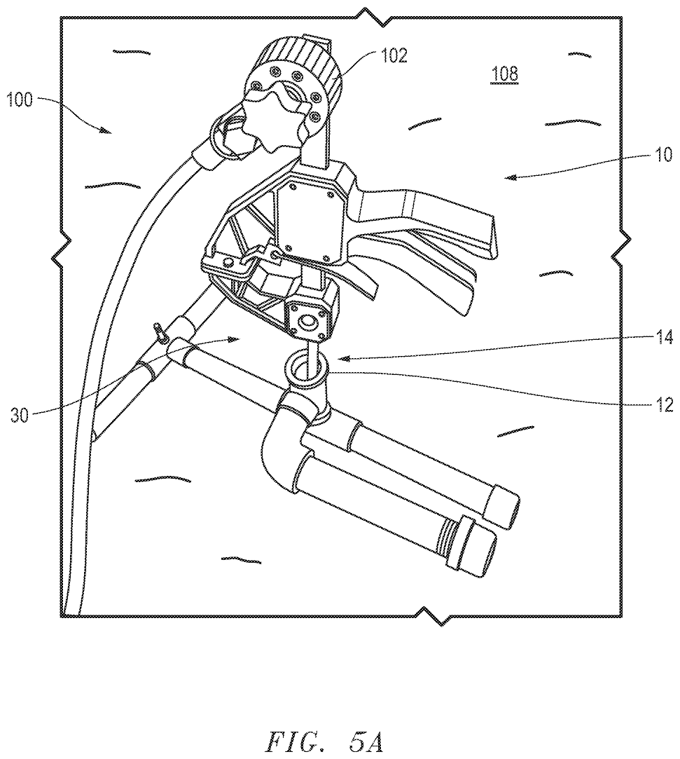

FIG. 5A depicts a perspective view of an exemplary embodiment of a conduit bore plugging apparatus 10 plugging a fluid path 14 of a conduit 12 while grounded with an electric grounding line 100. FIG. 5B depicts a perspective view of an exemplary embodiment of a grounding line 100 that is grounded to the ground surface 108. Referring to FIGS. 5A-5B, groundling line 100 may electrically ground conduit bore plugging apparatus 10. Grounding line 100 may connect at one end to bar 42 of bore plugging apparatus 10 and grounding line 100 may connect at another end to ground surface 108 and to a sufficient ground depth. By way of example only, grounding line 100 may connect to ground surface 108 via a stake 106 in the ground surface. By way of example only, grounding line 100 may comprise a first magnet 102 attached to a first end of the grounding line 100 for connecting to the bar 42, and a second magnet 104 attached to a second end of the grounding line 100 for connecting to a grounding stake 106 in the ground surface 108.

Referring to FIGS. 1-5B, a bore or fluid path 14 in a conduit 12 may be selectively plugged by driving a bar 42 via a trigger engaged driving chamber 22, and simultaneously guiding and supporting the bar 42 via a passage 32 defined by a brace 30, into the bore or fluid path 14 of the conduit 12; and expanding a seal 60 within the bore or fluid path 14 of the conduit 12 by sliding a sleeve 90 over a rod 44 of the bar 42 into a flange contiguous with an end of the seal 60, and by engaging the sleeve 90 at one end by interference with the abutment surface 132 of brace 30 (and/or rigid ring 50) as the bar 42 is driven via the driving chamber 22. By way of example only, the seal 60 may be expanded by sliding the sleeve 90 over the rod 44 by squeezing the trigger 24 engaging the driving chamber 22 of motive chamber 130 for selectively plugging the bore 14. By way of example only, the conduit 12 may be sealed by the expanding seal 60 by sliding the sleeve 90 over the rod 44 by squeezing the trigger 24 engaging the driving chamber 22 one or more times (e.g. twice, or as needed, to effectively expand expandable seal 60 and thereby plug the inner diameter of the bore 14 to prevent fluid flow through conduit 12, for example, up to sixty psi/pounds per square inch force), i.e., “quickly” within one to three seconds, for selectively plugging the fluid path 14 in a conduit 12 with expandable seal 60. The seal 60 within the bore 14 may be released (i.e., unexpanded or otherwise lessen the diameter) via release trigger 26 of the motive chamber 130 which may release engagement between the driving chamber 22 and the bar 42, and allow the bar to release in a second direction. The conduit bore plugging apparatus 10 may be grounded via grounding the bar 42 to a ground surface 108.

In an exemplary embodiment the bore plugging apparatus 10 including the shaft-like plugging device 40 is primarily made of metal components. Specifications of the conduit 12 and fluid path 14 to be selectively plugged will aid in determining the changeable size of the expandable seal/plug 60 to be selected for use. Whilst the bore plugging apparatus 10 may be primarily described for use in the natural gas industry, it may be used in association with any fluid including water, steam, and other fluids. The grounding line 100 is primarily useful to counteract to potential hazards from static electricity in the vicinity of a flammable or hazardous fluid such as natural gas. The driver handle 20 and the guiding and supporting brace 30 are showing as separate parts mechanically fixed together as creatively derived/adapted/modified from a prior art trigger clamp or bar clamp. However, the separate parts could be made as one integral or unitary piece. The rigid ring 50 could be other shapes so long as having dimensions that interfere with the brace 30 in relation to the size and shape of the passage 32.

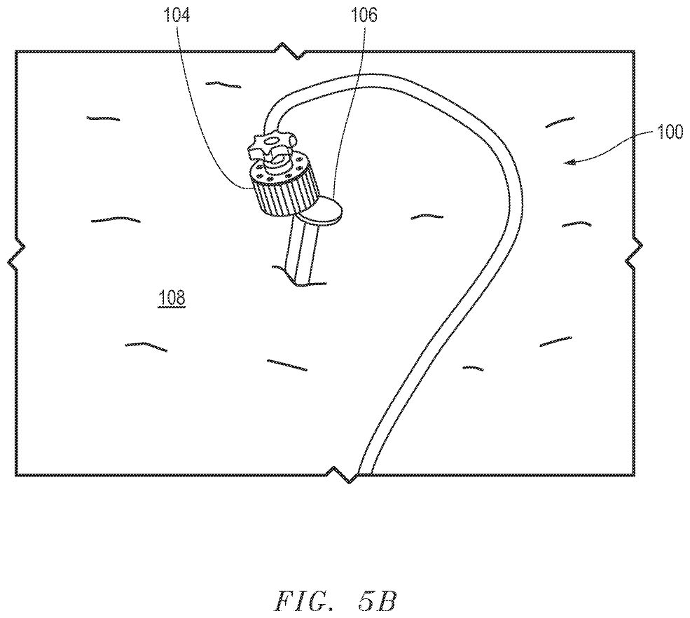

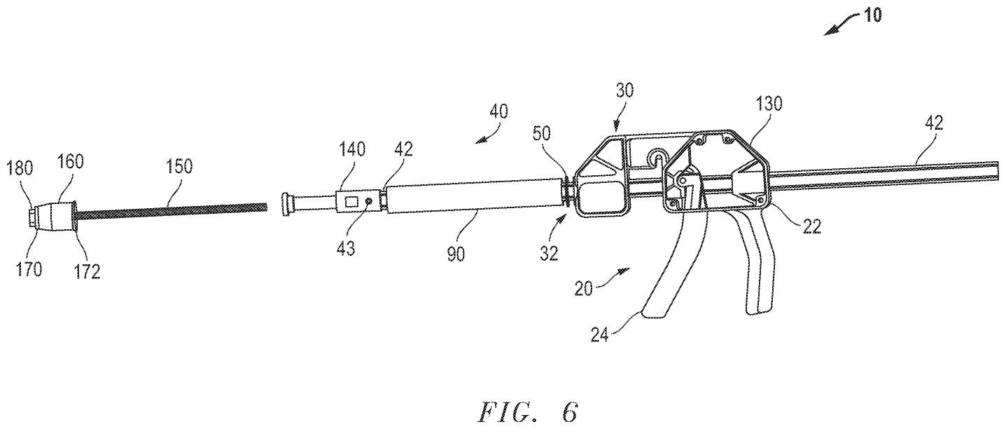

FIG. 6 depicts a side view of another exemplary embodiment of a conduit bore plugging apparatus 10 for rapid selective plugging of a fluid path within a conduit. The conduit bore plugging apparatus 10 may have a driver handle 20 having a motive chamber 130 with driving chamber 22 (with a motive release handle or trigger 26 as showing in FIG. 1). The motive chamber 130 may be connected (e.g., directly, indirectly, and/or unitary with, etc.) to the driver handle 20. The driver handle 20 may have a squeezable motive handle or trigger 24. The motive chamber 130 defines a passage 32. The conduit bore plugging apparatus 10 may further have a shaft-like plugging device 40 which comprises a bar 42 connected or attached to an adaptor 140 (see also FIG. 7), such as, for example, connected, attached, or fixed by a roll pin 43. The adaptor 140 is disposable around a threaded rod, rod or bolt 150, and is in abutting relationship with respect to a second flange 172. The threaded rod 150 is an internal rod that may be positioned inside of a rigid sleeve 90, which is hollow (or defines an internal duct) to permit passage of threaded rod 150. The threaded rod 150 is also an internal rod that may be positioned inside of the adaptor 140 (the adaptor 140 defines a passage 146 to permit passage of threaded rod 150). Rod or threaded rod 150 may be threaded to accommodate a fastener (e.g., but not limited to a cap or wing nut) 180 on one end, or threaded rod 150 may be integral as part of a bolt with the bolt functioning as fastener 180 and the threaded rod 150 contiguous or integral with the bolt head). An opposite end of threaded rod 150 may be welded or otherwise fixed, pinned, attached, connected, or threaded to bar 42 (and/or to adaptor 140). The bar 42 may be driven by the driver handle 20 via the driving chamber 22 of the motive chamber 130 and guided and supported by the motive chamber 130 via passage 32. A rigid ring 50 is disposed around the bar 42. The rigid ring 50 may have an outer diameter/dimension Y that is greater than an opening dimension (e.g., the width) X of the passage 32 for creating interference between rigid ring 50 outer diameter/dimension Y and the opening dimension X of the passage 32 on abutment surface 132. An expandable seal 160 is disposed around the threaded rod 150, such as at a distal end of threaded rod 150 relative to a driven end of bar 42 that passes through driving chamber 22. A first flange 170 and second flange (e.g., a separate flange or a washer-like device mounted on the bolt) 172 are disposed around the threaded rod 150. The first flange or a washer-like device 170 may be connected over the threaded rod 150 near the distal end of the threaded rod 150 and may be contiguous with a fastener 180 and contiguous with one end of the expandable seal 160. The second flange 172 may be attached or contiguous with another end of the expandable seal 160. The fastener 180 may be a bolt, cap, nut or wing nut 180 and may be fixed, such as with threads, to an end of the threaded rod 150 abutting the first flange 170 or integral with the threaded rod (such as in a bolt). Rigid sleeve 90 may be moved and disposed around the threaded rod 150 adjoining and in-between the rigid ring 50 and the second flange 172. The rigid sleeve 90 is slidable over, and around, the threaded rod 150. Stated slightly differently, threaded rod 150 slides internally through rigid sleeve 90.

Referring to FIG. 7, the adaptor 140 may be connected to bar 42 at a first end 142 with a rolled pin 43. The adaptor 140 is disposable around a threaded rod, rod or bolt 150, and is in abutting relationship at a second end 144 with respect to a second flange 172. The adaptor 140 defines an internal passage 146 for passage of threaded rod 150 and connection or attachment to the bar 42.

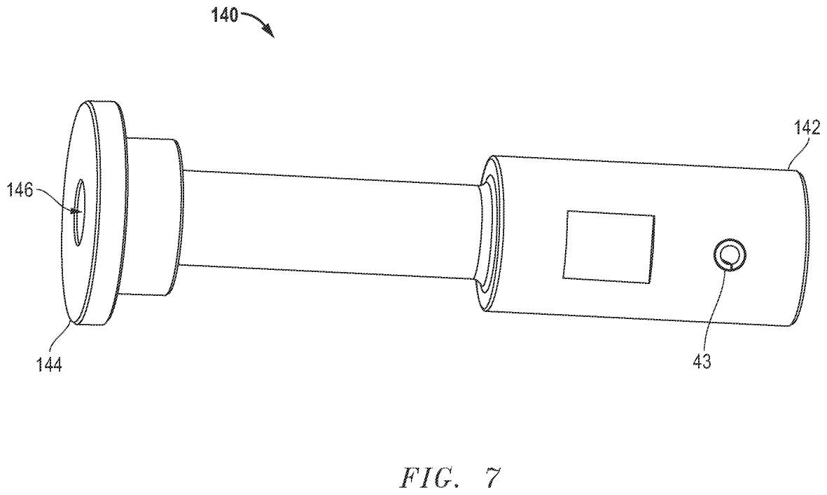

FIG. 8 depicts a side view of another exemplary embodiment of a conduit bore plugging apparatus 10 for rapid selective plugging of a fluid path within a conduit. The conduit bore plugging apparatus 10 may have a driver handle 20 having a motive chamber 130 with a driving chamber 22. The motive chamber 130 may be attached (e.g., directly, indirectly, and/or unitary with, etc.) to the driver handle 20. The driver handle 20 may have a squeezable trigger 24 and a release trigger 26. The motive chamber 130 defines a passage 32. The conduit bore plugging apparatus 10 may further have a shaft-like plugging device 40, rigid sleeve 90, and expandable seal 60 as in the other exemplary embodiments shown in FIG. 1 and in FIG. 6. A rigid ring 50 is excluded in the exemplary embodiment of FIG. 8. The rigid sleeve 90 may have an outer diameter/dimension & that is greater than an opening dimension (e.g., the width) X of the passage 32 for creating interference between rigid sleeve 90 outer diameter/dimension Y and the opening dimension X of the passage 32 on abutment surface 132. The expandable seal 60 is disposed around the rod 44, such as at a distal end of rod 44 relative to a driven end of bar 42 that passes through driving chamber 22 of motive chamber 130. A first flange 70 and second flange 72 are disposed around the rod 44. The first flange 70 may be attached to rod 44 near the distal end of the rod 44 and may be contiguous with one end of the expandable seal 60. The second flange 72 may be attached contiguous with another end of the expandable seal 60. A fastener, wing nut, bolt, or cap nut 80 (or the like) may be fixed, such as with threads to an end of the rod 44 abutting the first flange 70. Rigid sleeve 90 is disposed around the rod 44 adjoining and interposed between the abutment surface 132 and the second flange 72. The rigid sleeve 90 is slidable over, and around, the rod 44. Stated slightly differently, rod 44 slides internally through rigid sleeve 90.

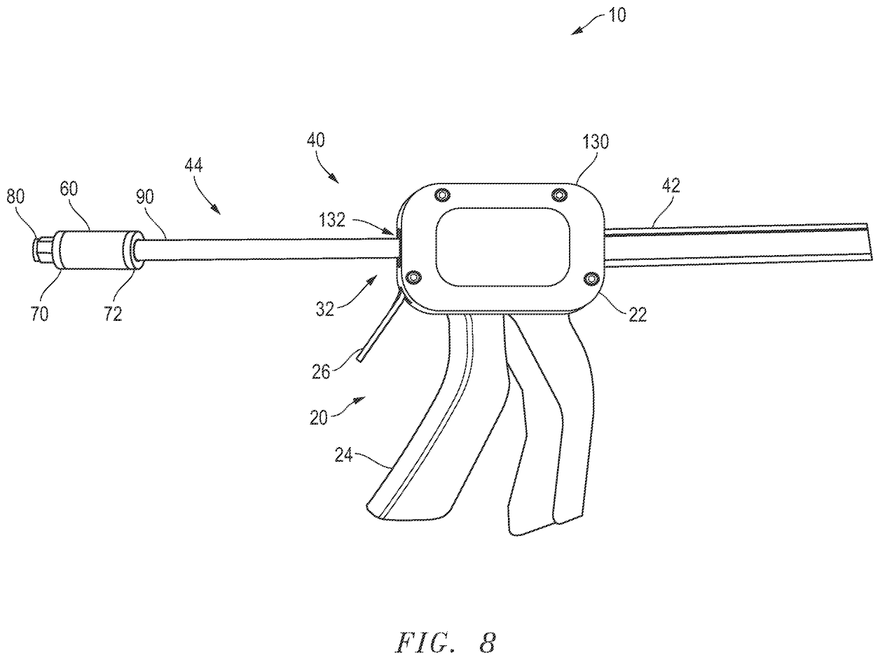

FIG. 9 depicts a schematic view of an exemplary embodiment of the passage 32 of the motive chamber 130 and rigid sleeve 90. By way of example only, the rigid sleeve 90 may have an outer diameter/dimension Y that is greater than an opening dimension (e.g., as shown in FIG. 9, the width) X of the passage 32 for creating interference between rigid sleeve 90 outer diameter/dimension Y and the opening dimension X of the passage 32 on abutment surface 132 of motive chamber 130. The rigid sleeve 90 by interference with the abutment surface 132 of motive chamber 130 may prevent the rigid sleeve 90 from passing into the passage 32 defined by the motive chamber 130 (shown in FIG. 8) when the bar 42 is driven in the first direction by the driver handle 20 (shown in FIG. 8) via the driving chamber 22 (shown in FIG. 8).

It is to be understood that the bar 42 and rod 150 could be integrated or a unitary device as the shaft-like plugging device 40 (with or without an adaptor 140). Such a shaft-like plugging device 40 would need to be configured at one end for being driven by the driver handle 20 via the driving chamber 22 and guided and supported by the motive chamber 130 via passage 32, and configured or threaded at the other end for connection through the expandable seal 160, first and second flanges 170 and 172 to a fastener 180. Also, different expandable plug 60/160 sizes (for example, via the adaptor 140) can be swapped out and replaced as needed for the selectively plugging of the fluid path 14 in a conduit 12 with expandable seal 60/160.

Referring to FIGS. 5A, 5B, and the exemplary embodiment of FIGS. 6-9, a bore or fluid path 14 in a conduit 12 may be selectively plugged by driving a bar 42 via a trigger engaged driving chamber 22, and simultaneously guiding and supporting the bar 42 via a passage 32 defined by the motive chamber 130, into the bore or fluid path 14 of the conduit 12; and expanding a seal 160 within the bore or fluid path 14 of the conduit 12 by sliding a sleeve 90 over the bar 42 and over a rod 150 into a second flange 172 contiguous with an end of the seal 160, and by engaging the sleeve 90 at one end by interference with the abutment surface 132 of motive chamber 130 (and/or rigid ring 50) as the bar 42 is driven in a first direction via the driving chamber 22. By way of example only, the seal 160 may be expanded by sliding the sleeve 90 over the threaded rod 150 (of bolt/fastener 180) by squeezing the motive handle or trigger 24 engaging the driving chamber 22 of motive chamber 130 for selectively plugging the bore 14. By way of example only, the conduit 12 may be sealed by the expanding seal 160 by sliding the sleeve 90 over the threaded rod 150 (of bolt/fastener 180) by squeezing the motive handle or trigger 24 engaging the driving chamber 22 one or more times (e.g. twice, or as needed, to effectively expand expandable seal 160 and thereby plug the inner diameter of the bore 14 to prevent fluid flow through conduit 12, for example, up to sixty psi/pounds per square inch force), i.e. “quickly” within one to three seconds, for selectively plugging the fluid path 14 in a conduit 12 with expandable seal 160. The expandable seal 160 within the bore 14 may be released (i.e., unexpanded or otherwise lessen the diameter) via release motive handle or trigger 26 of the motive chamber 130 which may release engagement between the driving chamber 22 and the bar 42, and allow the bar to release in a second direction. The conduit bore plugging apparatus 10 may be grounded via grounding the bar 42 to a ground surface 108.

While the exemplary embodiments are described with reference to various implementations and exploitations, it will be understood that these exemplary embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A conduit bore plugging apparatus for rapid selective plugging of a fluid path within a conduit, comprising:
a driver handle comprising a motive chamber attached to the driver handle, wherein the motive chamber defines a passage;
a shaft-like plugging device comprising a bar connected to a rod;
wherein the bar is driven by the driver handle via a driving chamber in the motive chamber, and guided and supported by the motive chamber via the passage;
an expandable seal disposed around the rod;
first and second flanges disposed around the rod, wherein the first flange is attached near a distal end of the rod and contiguous with one end of the expandable seal, and wherein the second flange is attached contiguous with another end of the expandable seal;
a fastener contiguous with the rod and abutting the first flange; and
a rigid sleeve disposable around the rod adjoining and interposed between the motive chamber and the second flange, wherein the rigid sleeve is slidable over the rod.

2. The conduit bore plugging apparatus according to claim 1, further comprising:
an abutment surface on the motive chamber surrounding the passage at one end of the motive chamber; and
wherein an outer diameter of the rigid sleeve is greater than an opening dimension of the passage.

3. The conduit bore plugging apparatus according to claim 1, further comprising:
a rigid ring disposed around the shaft-like plugging device and interposed between the motive chamber and the rigid sleeve;
wherein an outer diameter of the rigid ring is greater than an opening dimension of the passage; and
wherein the rigid sleeve is interposed between the rigid ring and the second flange.

4. The conduit bore plugging apparatus according to claim 1, wherein the motive chamber further comprises a guiding and supporting brace;
wherein the guiding and supporting brace further defines the passage; and
wherein the rigid sleeve is interposed between the guiding and supporting brace and the second flange.

5. The conduit bore plugging apparatus according to claim 1, wherein the bar is attached to the rod, and wherein the fastener comprises the rod integrated at a distal end as a bolt.

6. The conduit bore plugging apparatus according to claim 1, wherein the bar is welded to the rod, and wherein the rod is threaded at a distal end to the fastener.

7. The conduit bore plugging apparatus according to claim 1, further comprising an adaptor defining a passage disposable around the threaded rod and wherein the adaptor is connected between the bar and the rod.

8. The conduit bore plugging apparatus according to claim 1, further comprising an electrical grounding line connected at one end to the bar and connected at another end to a ground surface.

9. The conduit bore plugging apparatus according to claim 8, wherein the electrical grounding line further comprises a first magnet attached to a first end of the electrical grounding line for connecting to the bar; and a second magnet attached to a second end of the electrical grounding line for connecting to a grounding stake in the ground surface.

10. The conduit bore plugging apparatus according to claim 1, wherein the driver handle further comprises a squeezable trigger for engaging the driving chamber and driving the bar; and a release trigger for releasing the bar from the motive chamber.

11. The conduit bore plugging apparatus according to claim 1, wherein the expandable seal is a rubber plug.

12. A conduit bore plugging apparatus for rapid selective plugging of a fluid path within a conduit, comprising:
a driver handle comprising a motive chamber attached to the driver handle, wherein the motive chamber defines a passage;
a shaft-like plugging device comprising a bar connected to a rod;
wherein the bar is driven by the driver handle via a driving chamber in the motive chamber, and guided and supported by the motive chamber via the passage;
an expandable seal disposed around the rod;
first and second flanges disposed around the rod, wherein the first flange is attached near a distal end of the rod and contiguous with one end of the expandable seal, and wherein the second flange is attached contiguous with another end of the expandable seal;
a fastener contiguous with the rod and abutting the first flange;
a rigid sleeve disposable around the rod adjoining and interposed between the motive chamber and the second flange, wherein the rigid sleeve is slidable over the rod;
an abutment surface on the motive chamber surrounding the passage at one end of the motive chamber;
wherein an outer diameter of the rigid sleeve is greater than an opening dimension of the passage;
wherein the driver handle further comprises a squeezable trigger for engaging the driving chamber and driving the bar, and a release trigger for releasing the bar from the motive chamber; and
an electrical grounding line connected at one end to the bar and connected at another end to a ground surface.

13. A method for selectively plugging a bore in a conduit, comprising the steps of:
driving a bar via a trigger engaged driving chamber, and simultaneously guiding and supporting the bar via a passage defined by a motive chamber, into the bore of the conduit; and
expanding a seal within the bore of the conduit by sliding a sleeve over a rod of the bar into a flange contiguous with an end of the seal, and by engaging the sleeve at one end by interference with an abutment surface on the motive chamber as the bar is driven via the motive chamber.

14. The method for selectively plugging the bore in the conduit according to claim 13, further comprising the step of releasing the seal within the bore of the conduit by releasing engagement between the motive chamber and the bar.

15. The method for selectively plugging the bore in the conduit according to claim 13, further comprising the step of electrically grounding the bar to a ground surface.

16. The method for selectively plugging the bore in the conduit according to claim 13, wherein the step of expanding the seal within the bore of the conduit by sliding the sleeve over the rod further comprises squeezing the trigger engaging a driving chamber of the motive chamber once for selectively plugging the bore.

17. The method for selectively plugging the bore in the conduit according to claim 16, wherein the step of expanding the seal within the bore of the conduit by sliding the sleeve over the rod further comprises squeezing the trigger engaging the driving chamber of the motive chamber once more twice for selectively plugging the bore.
